(19) United States
(12) Patent Application Publication
(10) Pub. No.: US 2018/0160119 A1
(43) Pub. Date: Jun. 7, 2018

(54) Method and Apparatus for Adaptive Region-Based Decoding to Enhance User Experience for 360-degree VR Video

(71) Applicant: MEDIATEK INC., Hsin-Chu (TW)

(72) Inventors: Chin-fa SU, Tainan City (TW); Li-Wei LU, New Taipei City (TW); Kuan-Hung CHOU, New Taipei City (TW); Chien-Chang WANG, Zhubei City (TW)

(21) Appl. No.: 15/816,859

(22) Filed: Nov. 17, 2017

Related U.S. Application Data
(60) Provisional application No. 62/428,571, filed on Dec. 1, 2016.

(51) Int. Cl. H04N 19/137; H04N 19/142; H04N 19/162; H04N 19/172; H04N 19/44; H04N 19/543; H04N 19/55

(52) U.S. Cl. CPC H04N 19/137; H04N 19/142; H04N 19/162; H04N 19/55; H04N 19/44; H04N 19/543; H04N 19/172

(57) ABSTRACT

Methods and apparatus of video decoding for a 360-degree video sequence are disclosed. According to one method, a bitstream comprising compressed data for a previous 360-degree frame and a current 360-degree frame in a 360-degree video sequence is received. A first view region in the previous 360-degree frame associated with a first field of view is determined for a user at a previous frame time. An extended region from the first view region in the current 360-degree frame is determined based on user's viewpoint information. The extended region in the current 360-degree frame is then decoded. A second view region in the current 360-degree frame associated with an actual field of view is rendered for the user at a current frame time.

### CROSS REFERENCE TO RELATED APPLICATIONS

The present invention claims priority to U.S. Provisional Patent Application, Ser. No. 62/428,571, filed on Dec. 1, 2016. The U.S. Provisional Patent Application is hereby incorporated by reference in its entirety.

### FIELD OF THE INVENTION

The present invention relates to 360-degree video coding and processing. In particular, the present invention relates to decoding a view region from a 360° VR video sequence within the user's field of view. In particular, the present invention discloses an adaptive region-based video decoding according to the user's viewpoint behavior to enhance user's viewing experience.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree (360°) field of view. The “feeling as sensation of present” can be further improved by stereographic rendering. Accordingly, the panoramic video is being widely used in Virtual Reality (VR) applications.

Immersive video involves capturing a scene using one or multiple cameras to cover a panoramic view, such as 360-degree field of view. The immersive camera usually uses a set of cameras, arranged to capture 360° field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

While the 360° video provides all around scenes, a user often views only a limited field of view. Therefore, the decoder only needs to decode a portion (e.g. a view region) of each 360° frame and display the corresponding portion of the 360° frame to the user. However, a user may not always look at the same region. In practical usage, a user may look around so that the field of view may change from time to time. Accordingly, different regions need to be decoded and displayed. FIG. 1 illustrates an exemplary scenario for region-based decoding for viewing 360° video sequence, where a user moves his/her viewpoint from left to right. Frame 110 corresponds to the 360° frame at time T and the user is looking at the left side. In this case, only region 112 needs to be decoded and displayed. Frame 120 corresponds to the 360° frame at time (T+1) and the user is looking at the center. In this case, only region 122 needs to be decoded and displayed. Frame 130 corresponds to the 360° frame at time (T+2) and the user is looking to the right. In this case, only region 132 needs to be decoded and displayed.

The region that needs to be decoded and displayed can be determined according to a 3D projection model and the field of view. FIG. 2 illustrates an example of view region determination based on the field of view in the case of cube 3D model 212. Projection 210 illustrates the scenario that the user is looking at the right side of the cube. Area 216 on the right-side cube face corresponds to the region associated with the field of view. The corresponding region 214 needs to be decoded and displayed. The user then turns to the left as indicated by the arrow 218 to face the back side of the cube. In projection 220, area 226 on the back-side cube face corresponds to the region associated with the field of view. The corresponding region 224 needs to be decoded and displayed.

As shown above, the region-based decoding for the 360° frames needs to decode a field of view in response to user's current viewpoint. The user's viewpoint or viewpoint motion may be automatically detected if the user wears a head-mount display (HMD) device equipped with 3D motion sensors. The user's viewpoint may also be indicated by the user using a pointing device. In order to accommodate different fields of view for a 360° video sequence, various 3D coding systems have been developed in the field. For example, Facebook™ developed a pyramid coding system that streams 30 bitstreams corresponding to 30 different fields of view. However, only the visible field of view is treated as a main bitstream. The main bitstream is coded to allow full-resolution rendering while other bitstreams are coded at reduced resolutions. In FIG. 3, drawing 310 illustrates region 312 corresponding to the visible field of view. Only this region is coded in full resolution. Picture 320 illustrates an example of a 360° frame in the spherical form. Picture 330 illustrates an example of a selected field of view and a corresponding bitstream is generated for this field of view. Picture 340 illustrates an example of 30 fields of view for generating 30 bitstreams.

Qualcomm™ also developed a coding system to facilitate multiple fields of view. In particular, Qualcomm™ uses truncated square pyramid projection by projecting a select field of view to a front (i.e., main) cube face. Drawing 410 in FIG. 4 illustrates an example of projecting a selected field of view to front cube face F as indicated by a bold-lined square 412. Other five faces of the cube are labelled as R (right), L (left), T (top), D (down) and B (back) as shown in drawing 410. The main face is treated as a full-resolution picture while the remaining 5 faces are packed into one picture area as shown in drawing 420. Picture 430 illustrates an example of 30 projected pictures corresponding to 30 viewpoints associated with each sphere frame. A bitstream is generated for each viewpoint.

According to the conventional region-based multiple Fields of View (FOV) coding system, bitstreams for a large number of fields of view have to be generated. The large amount of data to be streamed will cause long network latency. When the user changes his/her viewpoint, the associated bitstream for updated viewpoint may not be available. Therefore, the user has to rely on the non-main bitstream to display the view region in reduced resolution. In some cases, part of data in the updated view region may not be available from any of the 30 bitstreams. Therefore, erroneous data in the updated view region may occur. Therefore, it is desirable to develop techniques to adaptively stream bitstreams according to different fields of view. Furthermore, it is desirable to develop an adaptive coding system that can facilitate different fields of view effectively without the needs for high bandwidth or long switching latency.

### BRIEF SUMMARY OF THE INVENTION

Methods and apparatus of video decoding for a 360-degree video sequence are disclosed. According to one method, a first view region in the previous 360-degree frame associated with a first field of view is determined for a user at a previous frame time. The previous 360-degree frame and the current 360-degree frame in a 360-degree video sequence can be decoded from a bitstream. An extended region from the first view region in the current 360-degree frame is determined based on user's viewpoint information. The extended region in the current 360-degree frame is then decoded. Furthermore, a second view region in the current 360-degree frame associated with an actual field of view can be rendered for the user at a current frame time.

In one embodiment, the extended region is enlarged in a turn direction when user's viewpoint turns. The extended region is reduced when the user's viewpoint is back to still. In another embodiment, the extended region is enlarged in a direction corresponding to previous viewpoint motion. The extended region can be enlarged according to predicted viewpoint motion derived using linear prediction of previous viewpoint motion. The extended region may also be enlarged according to predicted viewpoint motion derived using non-linear prediction of previous viewpoint motion. The extended region can be determined according to learning mechanism using user's view tendency. For example, the user's view tendency may comprise frequency of user's viewpoint change, speed of user's viewpoint motion, or both. In another embodiment, a predefined region is derived based on user's view information and the extended region corresponds to a smallest rectangular region covering both the first view region and the predefined region.

The present step of rendering the second view region may further comprise blurring any non-decoded region in the second view region.

### BRIEF DESCRIPTION OF THE DRAWINGS

FIG. 1 illustrates an exemplary scenario for region-based decoding for viewing 360° video sequence, where a user moves his/her viewpoint from left to right.

FIG. 2 illustrates an example of view region determination based on the field of view in the case of cube 3D model.

FIG. 3 illustrates a region-based decoding system proposed by Facebook™ for viewing a 360° video sequence, where 30 fields of view are formed for each 360° frame and 30 corresponding bitstreams are generated.

FIG. 4 illustrates a region-based decoding system proposed by Qualcomm™ for viewing a 360° video sequence, where 30 fields of view are formed for each 360° frame and 30 corresponding bitstreams are generated.

FIG. 5 illustrates an exemplary scenario of mismatched view matrix and decoded region, where artifacts may occur when a user changes his/her viewpoint.

FIG. 6 illustrates an example of adaptive region-based decoding for viewing a 360° video sequence, where an extended region is decoded to anticipate user's viewpoint change.

FIG. 7 illustrates an example of determining an extended region based on prediction of the viewpoint change.

FIG. 8 illustrates examples of expanding decoded region according to user's viewpoint moving history.

FIG. 9 illustrates examples of predicting a user's new viewpoint move according to his previous viewpoint moves.

FIG. 10 illustrates an example that non-decoded areas may still exist even with the extended decoded region and the present invention may blur the non-decoded area.

FIG. 11 illustrates an example of generating the extended decoded region using a smallest rectangular region covering a user's previous view region and a predefined region.

FIG. 12 illustrates an exemplary flowchart of a system that decodes extended region adaptively based on user's viewpoint according to an embodiment of the present invention.

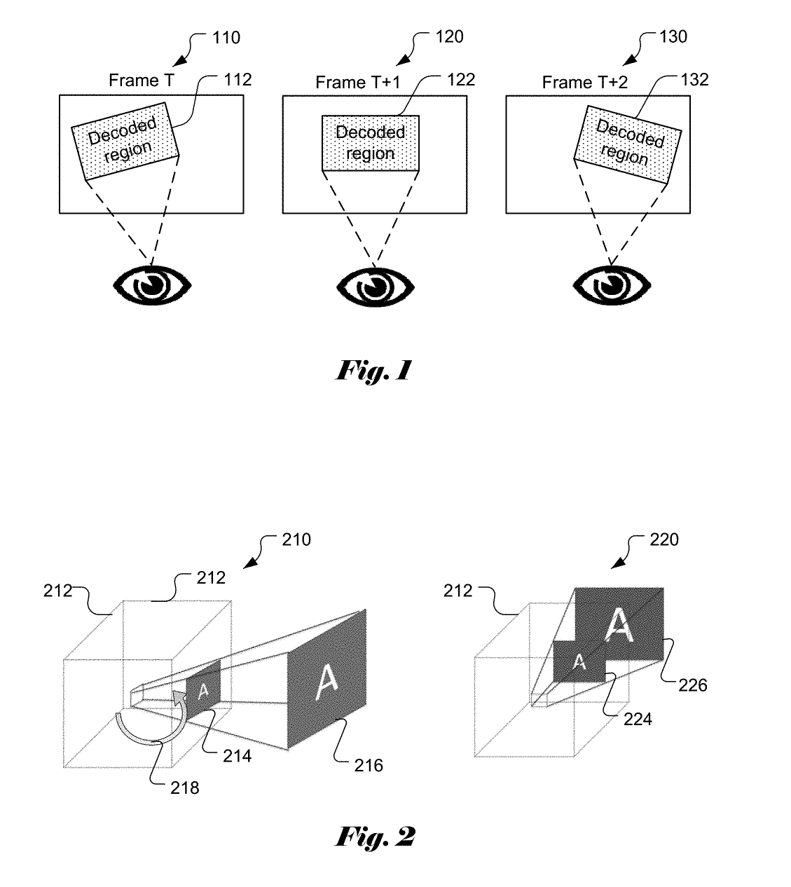

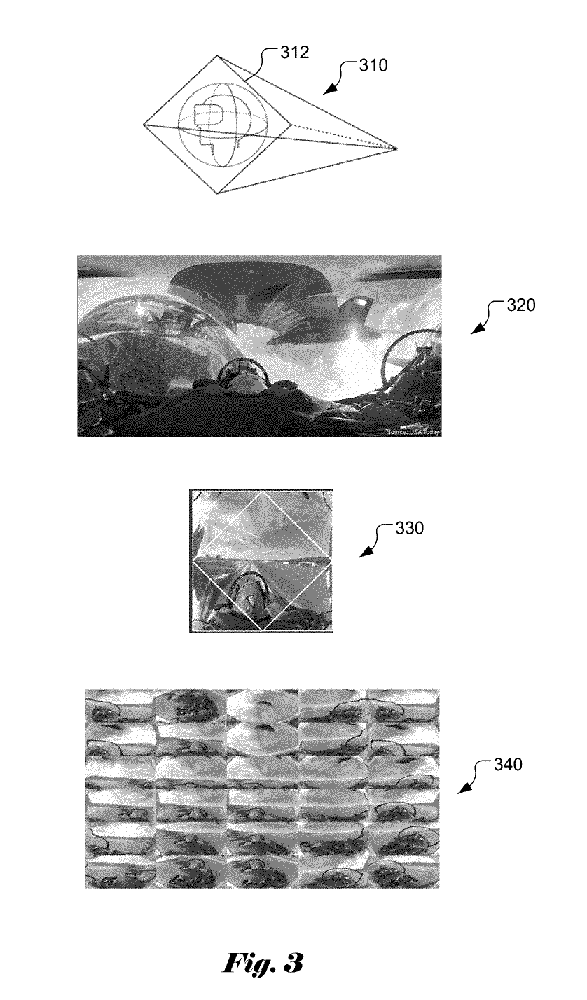

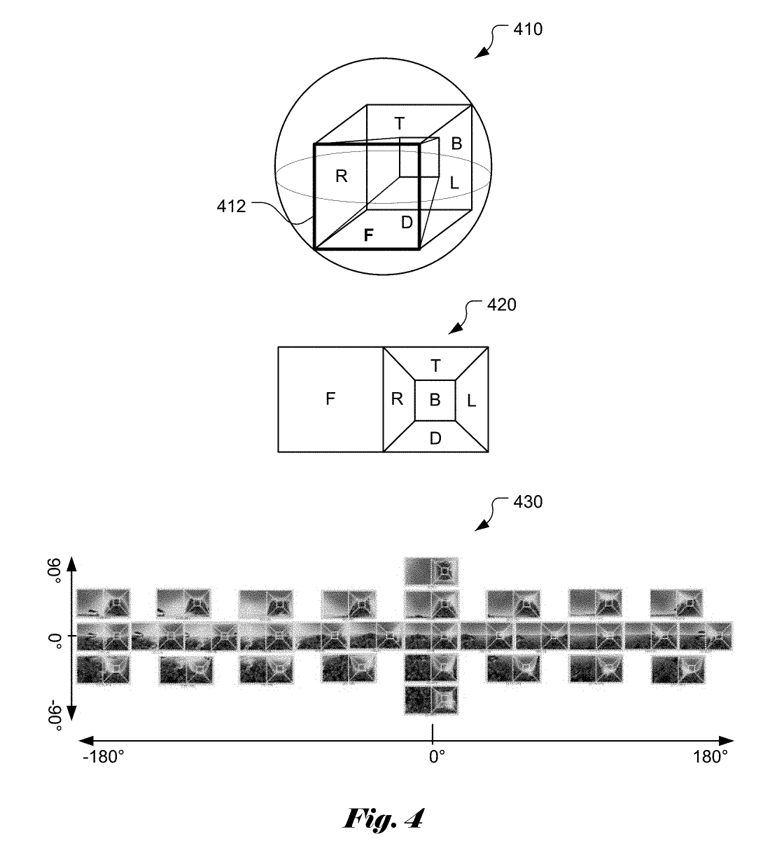

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, according to the conventional region-based multiple FOV coding system, bitstreams for a large number of fields of view have to be generated. When the user changes his/her field of view or viewpoint, the associated bitstream has to be switched, which may cause substantial latency depending on the network condition.

FIG. 5 illustrates an exemplary scenario, where artifacts may occur when a user changes his/her viewpoint. Frame 510 corresponds to a 360° frame at time T1 and region 512 corresponds to the view region at time T1. If the user turns his/her field of view to the lower right, the view region for T2 may move from picture 522 to picture 524 in frame 520. If a head-mount display (HMD) is used, the change of field of view can be detected from the HMD motion. The view region information can be provided to the decoder 530 to switch to a new stream corresponding to the new field of view. Since switching from the bitstream associated with the old field of view or viewpoint (i.e., region 522) at time T1 to the bitstream associated with the new field of view or viewpoint (i.e., region 524) at time T2 will take time, the decoder 530 may not be able to quickly decode the region 524. Therefore, some data in the new region (indicated by the dots-filled areas) may not be available. The new region will be displayed with artifacts corresponding to the erroneous data in the dots-filled areas.

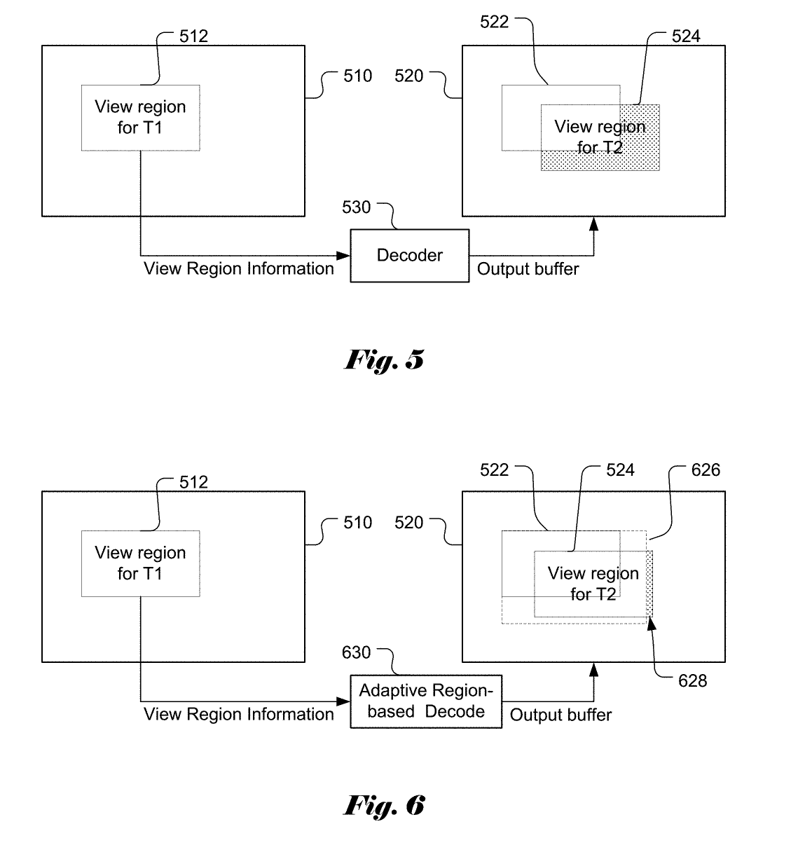

In order to overcome the issues associated with changing field of view, an adaptive coding system for 360° video sequences is disclosed. The adaptive decoding system extends the decoded region to anticipate the possible change in field of view. Therefore, when a user moves his/her viewpoint, the adaptive decoding system will likely provide new view region with less artifacts as shown in FIG. 6. According to the present invention, instead of decoding the region corresponding to the old field of view at time T2, the adaptive decoding system extends the decoded region to an extended region 626 as indicated by a dashed rectangle. In this example, the decoder anticipates the user may move his/her viewpoint to the lower right. In this example, the data in the actual view region 624 at time T2 will be mostly available except for a very small region 628 indicated by dots-filler area. The erroneous area 628 can be blurred to alleviate the visual annoyance or disturbance of the non-decoded area.

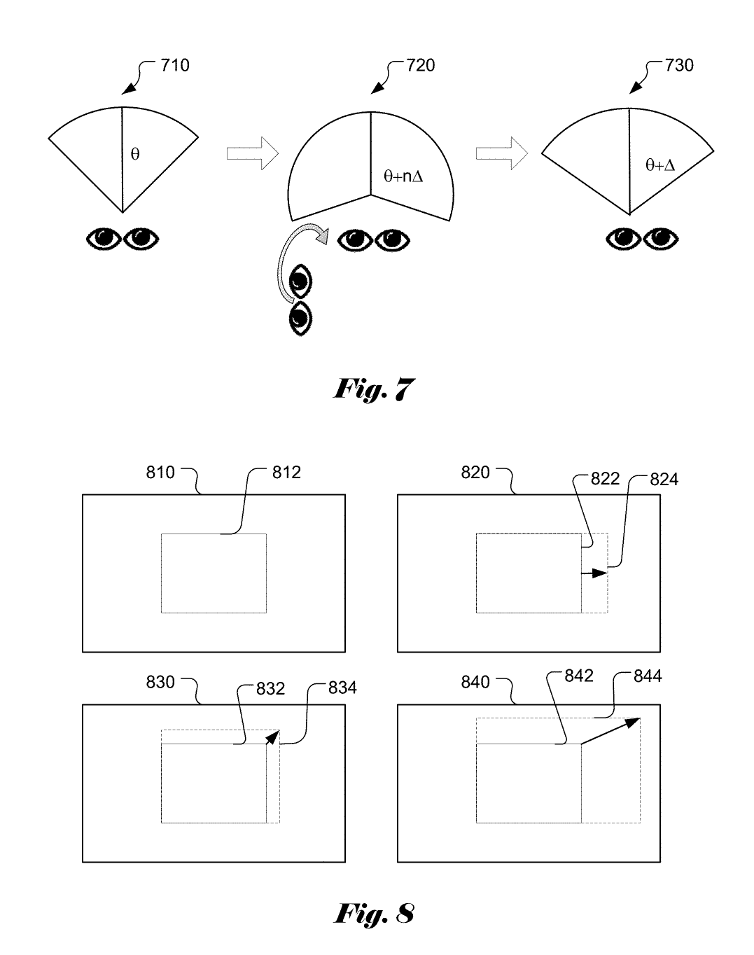

According to present invention, the view region is adaptively decoded based on prediction on user's behavior of turning. In particular, the decoded region is enlarged to prevent user from observing non-decoded area, which will provide better user experience due to better quality and less non-decoded area being rendered. The decoded region can be determined adaptively using prediction on viewpoint. FIG. 7 illustrates an example of prediction on viewpoint. Drawing 710 illustrates a user's viewpoint stays still with a viewing angle θ on each side from the center line. Drawing 720 illustrates a case that the user turns his/her viewpoint (clockwise or counterclockwise). In order to adapt to the changing field of view, an embodiment according to the present invention expands the decoded region by covering a viewing angle (θ+nΔ) on each side from the center line, where n is a positive integer and 4 is the increment in viewing angle. After the user's viewpoint goes back to still, the decoded region can be reduce to cover a viewing angle (θ+Δ).

According to another embodiment, the adaptive region decoding can be based on user's viewpoint moving history. For example, the prediction can be applied to arbitrary direction. Also, the prediction can be adapted to various velocities. Accordingly, the faster a user's viewpoint moves, the bigger the decode region is. FIG. 8 illustrates examples of expanding the decoded region according to user's viewpoint moving history. For frame 810, the user's viewpoint stays still at view region 812 and there is no need to expand the decoded region. For frame 820, the user's viewpoint moves from view region 822 to the right. According to this embodiment, the decoded region is expanded by extending the area on the right side to cover to region 824. For frame 830, the user's viewpoint moves slightly up-right from view region 832. According to this embodiment, the decoded region is expanded slightly by extending the area on the upper-right side to cover region 834. For frame 840, the user's view region 842 moves rapidly up-right. According to this embodiment, the decoded region is expanded by extending the area on the upper-right side substantially to cover region 844.

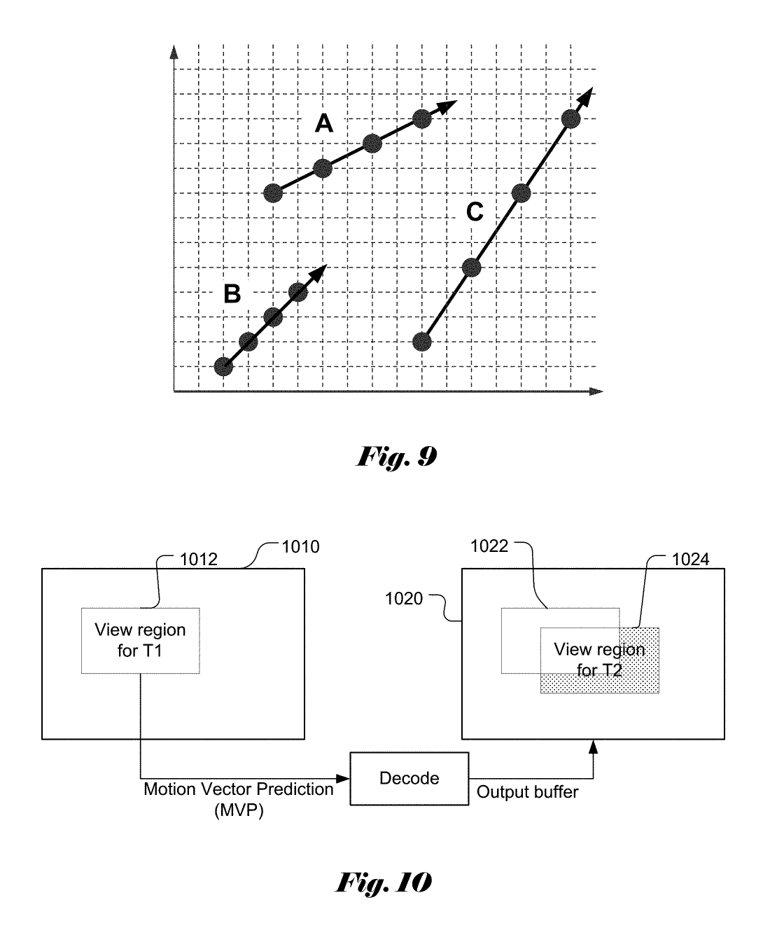

FIG. 9 illustrates examples of predicting a user's new viewpoint move according to his previous viewpoint moves. In FIG. 9, linear prediction is used to predict the next move, where 3 sets of moving histories i.e., A, B and C) are shown. Nevertheless, any algorithm (e.g. non-linear prediction) that uses past information to predict future outcomes can be applied.

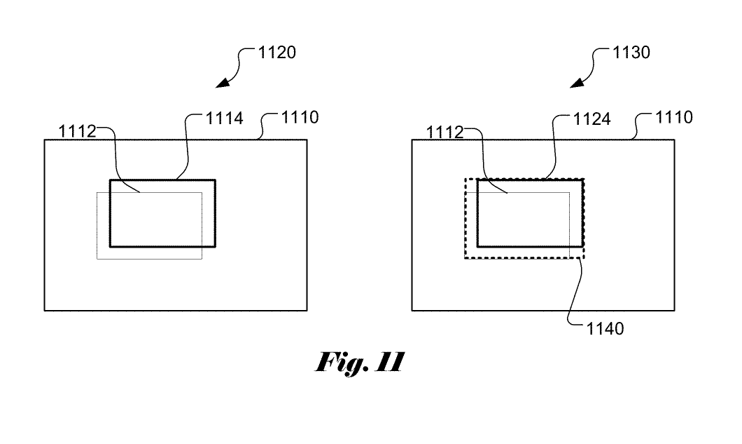

While the motion vector prediction (MVP) mentioned above may be used to extend the decoded region to reduce the possibility of non-decoded area, it won't guarantee that the new view region is always fully covered by the decoded region. In case that any non-decoded area occurs, an embodiment according to the present invention will blur the non-decoded area to reduce the visibility of the non-decoded data. In FIG. 10, even if motion vector prediction (MVP) is used, there are still possibilities that non-decoded areas exist. Frame 1010 corresponds to a 360° frame at time T1 and region 1012 corresponds to the view region at time T1. The view region for T2 may move from region 1022 to region 1024 in frame 1020. Therefore, some data in the new region (indicated by the dots-filled areas) may not be available. According to an embodiment of the present invention, the erroneous data indicated by the dots-filled areas will be blurred to reduce visual annoyance of the non-decoded area.

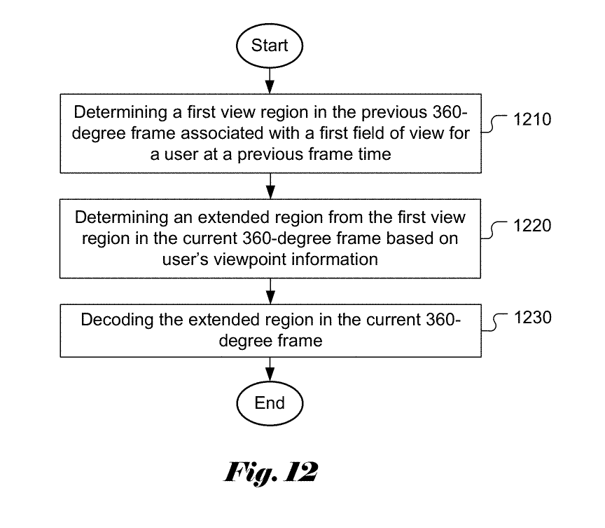

The view region prediction can be improved using learning mechanism. For example, the learning process can be based on user's view tendency, such as the frequency and the speed that the user changes his viewpoint. In another example, the learning mechanism can be based on video preference. For example, the user's view information can be collected and used to build a predefined prediction. FIG. 11 illustrates an example of generating the extended decoded region according to this embodiment. In drawing 1120, picture 1110 corresponds to a 360° frame, region 1112 corresponds to a user's view region and region 1114 corresponds to a predefined region derived according to this embodiment. In drawing 1130, the extended decoded region 1140 is determined as a smallest rectangular region covering both the user's view region and the predefined region.

The system according to the present invention is compared with the systems developed by Facebook™ and Qualcomm™ in Table 1.

TABLE 1

| | Present | | |
|---|---|---|---|
| | invention | Facebook ™ | Qualcomm ™ |
| Sphere mapping | Cube | Pyramid | Truncated square |
| | | | pyramid |
| UX enhancement | User FOV | Multi-view | Multi-view |
| | Prediction | streaming | streaming |
| Streaming bandwidth | High (4K) | Low (FHD) | Low (FHD) |
| Bitstream switching | No | Yes | Yes |
| latency | | | |
| Storage requirement | One 4k | 30 FHD | 30 FHD |
| | bitstream | bitstreams | bitstreams |
| Full quality FOV | 135 degrees | 90 degrees | 90 degrees |

While cube 3D model is used to generate the view region in the above examples, the present invention is not limited to use the cube 3D model. In Table 1, the present invention is configured to support 135 degrees of FOV. Nevertheless, any other FOV coverage may be used.

FIG. 12 illustrates an exemplary flowchart of a system that decodes extended region adaptively based on user's viewpoint according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, a first view region in the previous 360-degree frame associated with a first field of view for a user at a previous frame time is determined in step 1210. The previous 360-degree frame and the current 360-degree frame in a 360-degree video sequence can be decoded from a bitstream. An extended region is determined from the first view region in the current 360-degree frame based on user's viewpoint information in step 1220. The extended region in the current 360-degree frame is decoded in step 1230. A second view region in the current 360-degree frame associated with an actual field of view for the user at a current frame time can be rendered.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding for a 360-degree video sequence, the method comprising:
determining a first view region in a previous 360-degree frame associated with a first field of view for a user at a previous frame time;
determining an extended region from the first view region in a current 360-degree frame based on user's viewpoint information; and
decoding the extended region in the current 360-degree frame.

2. The method of claim 1, wherein the extended region is enlarged in a turn direction when user's viewpoint turns.

3. The method of claim 2, wherein the extended region is reduced when the user's viewpoint is back to still.

4. The method of claim 1, wherein the extended region is enlarged in a direction corresponding to previous viewpoint motion.

5. The method of claim 4, wherein the extended region is enlarged according to predicted viewpoint motion derived using linear prediction of previous viewpoint motion.

6. The method of claim 4, wherein the extended region is enlarged according to predicted viewpoint motion derived using non-linear prediction of previous viewpoint motion.

7. The method of claim 1, wherein the extended region is determined according to learning mechanism using user's view tendency.

8. The method of claim 7, wherein the user's view tendency comprises frequency of user's viewpoint change, speed of user's viewpoint motion, or both.

9. The method of claim 7, wherein a predefined region is derived based on user's view information and the extended region corresponds to a smallest rectangular region covering both the first view region and the predefined region.

10. The method of claim 1, further comprising rendering a second view region in the current 360-degree frame associated with an actual field of view for the user at a current frame time, and wherein said rendering the second view region blurs any non-decoded region in the second view region.

11. An apparatus for video decoding for a 360-degree video sequence, the apparatus comprising one or more electronics or processors arranged to:
determine a first view region in a previous 360-degree frame associated with a first field of view for a user at a previous frame time;
determine an extended region from the first view region in a current 360-degree frame based on user's viewpoint information; and
decode the extended region in the current 360-degree frame.

12. The apparatus of claim 11, wherein the extended region is enlarged in a turn direction when user's viewpoint turns.

13. The apparatus of claim 12, wherein the extended region is reduced when the user's viewpoint is back to still.

14. The apparatus of claim 11, wherein the extended region is enlarged in a direction corresponding to a previous viewpoint motion.

15. The apparatus of claim 14, wherein the extended region is enlarged according to predicted viewpoint motion derived using linear prediction of previous viewpoint motion.

16. The apparatus of claim 14, wherein the extended region is enlarged according to predicted viewpoint motion derived using non-linear prediction of previous viewpoint motion.

17. The apparatus of claim 11, wherein the extended region is determined according to learning mechanism using user's view tendency.

18. The apparatus of claim 17, wherein the user's view tendency comprises frequency of user's viewpoint change, speed of user's viewpoint motion, or both.

19. The apparatus of claim 17, wherein a predefined region is derived based on user's view information and the extended region corresponds to a smallest rectangular region covering both the first view region and the predefined region.

20. The apparatus of claim 11, said one or more electronics or processors are arranged to further render a second view region in the current 360-degree frame associated with an actual field of view for the user at a current frame time, and wherein any non-decoded region in the second view region is blurred.
